(19) United States
(12) Patent Application Publication
(10) Pub. No.: US 2025/0222557 A1
(43) Pub. Date: Jul. 10, 2025

(54) CARRIER PLATE POSITIONING DEVICE FOR MULTI-COLUMN HIGH-PRECISION POLISHING MACHINE

(71) Applicants: JINLING (CHINA) TECH GROUP CO., LTD, Changsha, Hunan (CN); LEIMIX GROUP (GUANGDONG) CO., LTD, Guangzhou, Guangdong (CN)

(72) Inventors: Shengan GUO, Changsha (CN); Limeng LEI, Changsha (CN); Renyan LAI, Changsha (CN)

(21) Appl. No.: 18/701,895

(22) PCT Filed: Jun. 5, 2023
(86) PCT No.: PCT/CN2023/098327

§ 371 Date: Apr. 16, 2024

(30) Foreign Application Priority Data
Mar. 2, 2023 (CN) 202310189821.3

(51) Int. Cl. B24B 41/06; B24B 7/22; B24B 29/02

(52) U.S. Cl. CPC B24B 41/068; B24B 7/228; B24B 29/02

(57) ABSTRACT

A carrier plate positioning device includes a lower plate and at least two upper plates that are provided on a machine body of the polishing machine, each upper plate being mounted with one carrier plate, a center positioning assembly and a plurality of outer positioning assemblies are provided on the machine body, when the plurality of carrier plates provided with workpieces to be polished are placed on the lower plate, the center positioning assembly is placed on an array center of the plurality of carrier plates from top to bottom, then each outer positioning assembly positions a corresponding carrier plate between the outer positioning assembly and the center positioning assembly inwardly from an outer side of the lower plate, and then each carrier plate is engaged with the corresponding upper plate by moving the upper plate downwards.

### CROSS-REFERENCE TO RELATED APPLICATIONS

This application is an U.S. national phase application under 35 U.S.C. § 371 based upon international patent application No. PCT/CN2023/098327, filed on Jun. 5, 2023, which itself claims priority to Chinese patent application No. 2023101898213 filed on Mar. 2, 2023. The contents of the above identified applications are hereby incorporated herein in their entireties by reference.

### TECHNICAL FIELD

The present disclosure relates to polishing equipment, in particular to a carrier plate positioning device of a multi-column high-precision polishing machine.

### BACKGROUND

Currently, the surface precision of components such as chips is required to be high, and polishing machines are generally used for polishing. Multi-column polishing machine is used more and more widely because it can polish multiple components at the same time. Especially, multi-column high-precision polishing machine not only has high efficiency, but also has high polishing precision for the polishing of components such as chips. With the development of science and technology, sapphire chips have appeared. As a main material of LED chip substrate, its substrate has been widely used because of its excellent mechanical properties, stability and optical permeability. In order to produce a sapphire chip substrate of suitable thickness and roughness, it must be back ground, then front ground and polished. When processing and polishing the sapphire chip substrate, the existing method is that the sapphire chip substrate is bonded on a carrier plate, then the sapphire chip substrate and the carrier plate are placed in a designated area of a lower plate, the position of the lower plate is adjusted to enable the carrier plate to be aligned with an upper plate, then the upper plate is moved down to enable the carrier plate to be engaged with the upper plate, and finally the polishing machine is started to polish. The whole process of this method is mostly manual operation, and the time for positioning the carrier plate is long, the carrier plate is not accurate enough to be engaged with the upper plate, repeated operation is often required, and the positioning efficiency is low.

### SUMMARY

In view of the above technical problem, the present disclosure provides a carrier plate positioning device of a multi-column high-precision polishing machine, which is accurate and rapid in positioning.

The technical solution adopted by the present disclosure to solve the above technical problem is as follows: a carrier plate positioning device for a multi-column high-precision polishing machine, includes a lower plate and at least two upper plates that are provided on a machine body of the polishing machine, each upper plate being mounted with one carrier plate, a center positioning assembly and a plurality of outer positioning assemblies are provided on the machine body, when the plurality of carrier plates carrying workpieces to be polished are placed on the lower plate, the center positioning assembly is placed on an array center of the plurality of carrier plates from top to bottom, then each outer positioning assembly positions a corresponding carrier plate between the outer positioning assembly and the center positioning assembly inwardly from an outer side of the lower plate, and then each carrier plate is engaged with the corresponding upper plate by moving the upper plate downwards.

Preferably, the center positioning assembly includes a center positioning base fixed on the machine body, a center cylinder provided on the center positioning base, and a center transmission mechanism driven by the center cylinder, a positioning plate is connected to a lower end of the center transmission mechanism, the center cylinder drives the positioning plate to rotate and move up and down through the center transmission mechanism, and when the positioning plate moves downward to the lower plate, the positioning plate abuts against inner side walls of the plurality of carrier plates on the lower plate through rotation.

Preferably, the center cylinder is mounted on a cylinder base fixedly connected to an upper end of the center positioning base, the center transmission mechanism includes a shaft sleeve fixedly connected to a lower end of the center positioning base and a center positioning shaft mounted in the shaft sleeve through a bearing, an upper end of the center positioning shaft is hinged to the center cylinder through a floating joint, and a lower end of the center positioning shaft is connected to the positioning plate.

Preferably, a wall of the shaft sleeve is axially provided with an inclined groove, a bolt-type roller needle bearing is provided along a radial direction of the shaft sleeve, a bolt end of the bolt-type roller needle bearing is radially locked on the central positioning shaft, a roller end is placed into the inclined groove, and when the center cylinder drives the center positioning shaft to move up and down, the roller end of the bolt-type roller needle bearing moves along the inclined groove to drive the center positioning shaft to rotate.

Preferably, the positioning plate includes a plate body fixedly connected to the lower end of the center positioning shaft and a positioning ring provided on a lower side of the plate body, a side wall of the positioning ring is circumferentially provided with a plurality of arc-shaped engaging openings, and when the positioning ring moves downward to the lower plate along with the plate body, the inner side wall of each carrier plate is engaged with the corresponding arc-shaped engaging opening.

Preferably, each outer positioning assembly includes a fixing bottom housing provided on the machine body and located the outer side of the lower plate, a side cylinder mounted on the fixing bottom housing, and a side positioning plate driven by the side cylinder through a side transmission mechanism, and when the plurality of carrier plates are placed on the lower plate, the side positioning plate is driven by the side transmission mechanism to approach the corresponding carrier plate from outside to inside and abuts against the outer side wall of the carrier plate.

Preferably, the side transmission mechanism includes a rack and pinion mechanism and a rotating mechanism, the side cylinder drives the rotating mechanism to rotate through the rack and pinion mechanism, and the rotating mechanism drives the side positioning plate to move from the outer side of the lower plate to the inner side of the lower plate.

Preferably, the rack and pinion mechanism includes a rack provided in the fixing bottom housing and connected to a telescopic rod of the side cylinder through a fisheye joint, and a gear horizontally arranged in the fixing bottom housing and engaged with the rack, the rotating mechanism includes a rotating shaft vertically arranged and a swinging assembly horizontally arranged, a lower end of the rotating shaft is mounted on an inner ring of the gear, the lower end of the rotating shaft is mounted with a deep groove ball bearing provided in the fixing bottom housing and located on an upper side of the gear, an upper end of the rotating shaft is connected to the swinging assembly, the rotating shaft is driven to rotate by the gear, so as to drive the swinging assembly to swing, and the swinging assembly drives the side positioning plate to swing.

Preferably, the swinging assembly includes a fixing base connected to the fixing bottom housing and a swinging arm horizontally arranged, an end of the swinging arm is fixedly connected to the upper end of the rotating shaft, and another end of the swinging arm is connected to the side positioning plate through a moving shaft vertically arranged.

Preferably, the workpiece to be polished is a sapphire chip substrate, and the carrier plate is a ceramic carrier plate.

According to the technical solution, the center positioning assembly and the outer positioning assembly are used. The center positioning assembly is configured to position the carrier plate outward from the inner side, and the outer positioning assembly is configured to position the carrier plate inward from the outer side, so that the plurality of carrier plates are accurately positioned between the center positioning assembly and the outer positioning assembly, and it is ensured that each carrier plate can be accurately engaged with the corresponding upper plate, thereby greatly saving time. It can be seen that the positioning device is not only simple in structure, high in intelligent, but also accurate and fast in positioning.

### BRIEF DESCRIPTION OF THE DRAWINGS

FIG. 1 is a perspective view of a preferred embodiment of the present disclosure.

FIG. 2 is a top view of a preferred embodiment of the present disclosure.

FIG. 3 is a partial sectional perspective view of a center positioning assembly of the present disclosure.

FIG. 4 is a partial sectional perspective view of an outer positioning assembly of the present disclosure.

### DETAILED DESCRIPTION OF THE EMBODIMENTS

The present disclosure will now be described in detail with reference to the accompanying drawings, and the illustrative embodiments and description of the present disclosure are used to explain the present disclosure, but are not intended to limit the present disclosure.

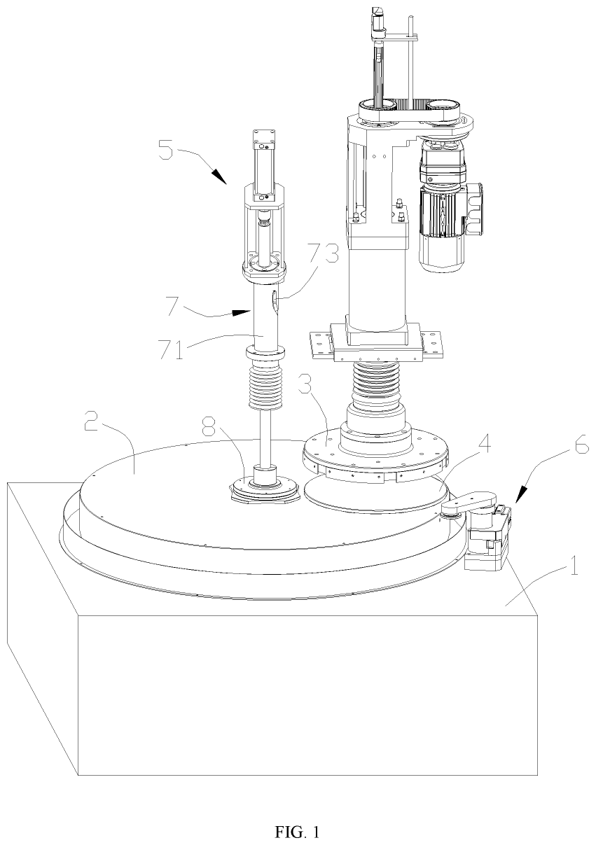

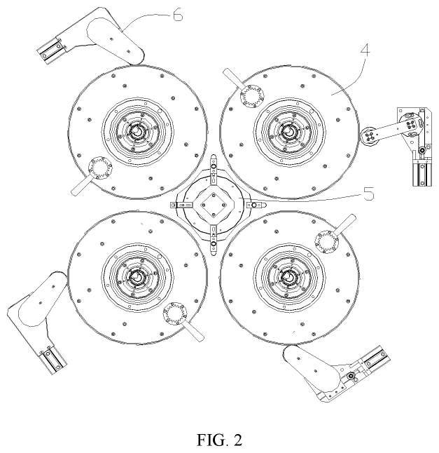

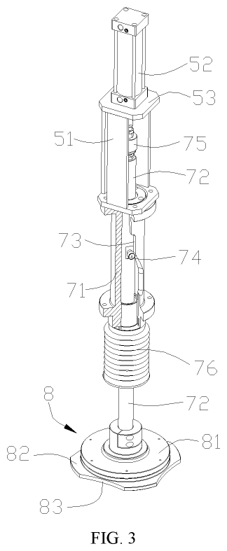

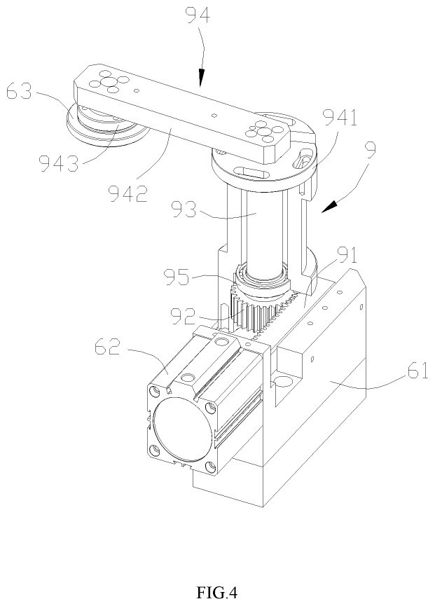

As shown in FIGS. 1 to 4, the present disclosure provides a carrier plate positioning device for a multi-column high-precision polishing machine. The carrier plate positioning device includes a lower plate 2 and at least two upper plates 3 that are provided on a machine body 1 of the polishing machine. Taking four upper plates 3 as an example in the present disclosure, each upper plate 3 is mounted with one carrier plate 4. A center positioning assembly 5 and a plurality of outer positioning assemblies 6 are provided on the machine body 1. When the plurality of carrier plates 4 provided with workpieces to be polished are placed on the lower plate 2, the center positioning assembly 5 is placed on an array center of the plurality of carrier plates 4 from top to bottom, then each outer positioning assembly 6 positions a corresponding carrier plate 4 between the outer positioning assembly 6 and the center positioning assembly 5 inwardly from an outer side of the lower plate 2, and each carrier plate 4 is engaged with the corresponding upper plate 3 by moving the upper plate 3 downwards, and finally the polishing machine is started to polish the workpieces to be polished. In an embodiment, the workpieces to be polished are mobile phone components, chips, etc. When polishing a sapphire chip substrate, a ceramic carrier plate 4 is preferably used to improve polishing accuracy. The mechanical structures of the center positioning assembly 5 and the outer positioning assembly 6 are simple, and the movement of the center positioning assembly 5 and the outer positioning assembly 6 are automatically controlled by control software without manual operation, which not only improves the intelligent of the device, but also provides accurate and fast positioning.

Specifically, the center positioning assembly 5 includes a center positioning base 51 fixed on the machine body 1, a center cylinder 52 provided on the center positioning base 51, and a center transmission mechanism 7 driven by the center cylinder 52. A positioning plate 8 is connected to a lower end of the center transmission mechanism 7, and the center cylinder 52 drives the positioning plate 8 to rotate and move up and down through the center transmission mechanism 7. When the positioning plate 8 moves downward to the lower plate 2, the positioning plate 8 abuts against inner side walls of the plurality of carrier plates 4 on the lower plate 2 through rotation, thereby preventing the carrier plate 4 from moving to an inner side of the lower plate 2. Preferably, the center cylinder 52 is mounted on a cylinder base 53 fixedly connected to an upper end of the center positioning base 51. The center transmission mechanism 7 includes a shaft sleeve 71 fixedly connected to a lower end of the center positioning base 51 and a center positioning shaft 72 mounted in the shaft sleeve 71 through a bearing. An upper end of the center positioning shaft 72 is connected to the center cylinder 52, and a lower end of the center positioning shaft 72 is connected to the positioning plate 8. When the center cylinder 52 extends or contracts, the center positioning shaft 72 descends or ascends, and then the positioning plate 8 is driven to approach or move away from the lower plate 2. The center transmission mechanism 7 of the present disclosure has few components, simple structure and high transmission precision, and can achieve precise control.

Further, a wall of the shaft sleeve 71 is axially provided with an inclined groove 73. A bolt-type roller needle bearing 74 is provided along a radial direction of the shaft sleeve 71. A bolt end of the bolt-type roller needle bearing 74 is radially locked on the center positioning shaft 72, and a roller end of the bolt-type roller needle bearing 74 is placed into the inclined groove 73. When the center cylinder 52 drives the center positioning shaft 72 to move up and down, the roller end of the bolt-type roller needle bearing 74 moves along the inclined groove 73 to drive the center positioning shaft 72 to rotate. Due to the restriction of the inclined groove 73, the center positioning shaft 72 can rotate according to a designed angle, that is, an inclination of the inclined groove 73 designed on the wall of the shaft sleeve 71, such as a spiral type, can realize the rotation of the center positioning shaft 72 according to the designed angle, so as to achieve the purpose of accurate control. The present disclosure also skillfully uses the bolt-type roller needle bearing 74, which is not only easy to obtain material and mount, and have low cost, but also generate rolling friction between the roller end moving along the inclined groove 73 and a wall of the inclined groove 73, which has less resistance and less wear, which is beneficial to improve the service life of device.

In an embodiment, a telescopic rod of the center cylinder 52 is hinged to the upper end of the center positioning shaft 72 through a floating joint 75, that is, the floating joint 75, such as a ball joint, can ensure that the center positioning shaft 72 can rotate relative to the telescopic rod when being driven by the center cylinder 52 to move up and down. The lower end of the center positioning shaft 72 is sleeved with a protective cover 76, which is waterproof and dust-proof, and especially can prevent cooling liquid, etc., from sputtering on the center positioning shaft 72 during the operation of the polishing machine, thereby preventing a vertical movement of the center positioning shaft 72 from being affected. Preferably, the positioning plate 8 includes a plate body 81 fixedly connected to the lower end of the center positioning shaft 72 and a positioning ring 82 provided on a lower side of the plate body 81. The positioning ring 82 is generally made of flexible material to prevent damage to the carrier plate 4. A side wall of the positioning ring 82 is circumferentially provided with a plurality of arc-shaped engaging openings 83. When the positioning ring 82 moves downward to the lower plate 2 along with the plate body 81, the inner side wall of each carrier plate 4 is engaged with the corresponding arc-shaped engaging opening, so as to accurately position the carrier plate 4 and prevent the carrier plate 4 from sliding.

Each outer positioning assembly 6 of the present disclosure includes a fixing bottom housing 61 provided on the machine body 1 and located the outer side of the lower plate 2, a side cylinder 62 mounted on the fixing bottom housing 61, and a side positioning plate 63 driven by the side cylinder 62 through a side transmission mechanism 9. When the plurality of carrier plates 4 are placed on the lower plate 2, the side positioning plate 63 is driven by the side transmission mechanism to approach the corresponding carrier plate 4 from outside to inside and abuts against the outer side wall of the carrier plate 4, thereby preventing the carrier plate 4 from sliding outward. Specifically, the side transmission mechanism 9 includes a rack and pinion mechanism and a rotating mechanism. The side cylinder 62 drives the rotating mechanism to rotate through the rack and pinion mechanism. The rotating mechanism drives the side positioning plate 63 to move from the outer side of the lower plate 2 to the inner side of the lower plate 2 until the side positioning plate 63 abuts against the outer side wall of the corresponding carrier plate 4. The side positioning plate 63 is made of nylon, so as to prevent causing damage when being in contact with the carrier plate 4.

In an embodiment, the rack and pinion mechanism includes a rack 91 provided in the fixing bottom housing 61 and connected to a telescopic rod of the side cylinder 62 through a fisheye joint, and a gear 92 horizontally arranged in the fixing bottom housing 61 and engaged with the rack 91. The rotating mechanism includes a rotating shaft 93 vertically arranged and a swinging assembly 94 horizontally arranged. A lower end of the rotating shaft 93 is mounted on an inner ring of the gear 92. The lower end of the rotating shaft 93 is mounted with a deep groove ball bearing 95 which is provided in the fixing bottom housing 61 and located on an upper side of the gear 92. The deep groove ball bearing 95 mounted in the fixing bottom housing 61 can support the gear 92 and the rotating shaft 93, and ensure that the gear 92 and the rotating shaft 93 are firmly mounted and stably transmitted. An upper end of the rotating shaft 93 is connected to the swinging assembly 94. When the side cylinder 62 drives the rack 91 to move, the rack 91 drives the gear 92 to rotate, the rotating shaft 93 is driven to rotate by the gear 92, so as to drive the swinging assembly 94 to swing. The swinging assembly 94 drives the side positioning plate 63 to swing, so as to approach or move away from the carrier plate 4 on the lower plate 2.

Preferably, the swinging assembly 94 includes a fixing base 941 connected to the fixing bottom housing 61 and a swinging arm 942 horizontally arranged. One end of the swinging arm 942 is fixedly connected to the upper end of the rotating shaft 93, and the other end of the swinging arm 942 is connected to the side positioning plate 63 through a moving shaft 943 vertically arranged. The moving shaft can ensure that the side positioning plate 63 can rotate after being in contact with the carrier plate 4, thereby reducing wear on the carrier plate 4. The rotating shaft 93 drives the swinging arm 942 to rotate, that is, the other end of the swinging arm 942 rotates around the one end of the swinging arm 942. As the rotating shaft 93 rotates clockwise or counterclockwise, the other end of the swinging arm 942 is approach or move away from the carrier plate 4. When positioning is required, the swinging arm 942 swings to the carrier plate 4, and the side positioning plate 63 abuts against the outer side wall of the carrier plate 4. When the positioning is completed, the swinging arm 942 drives the side positioning plate 63 to move away from the carrier plate 4 and is located on the outer side of the lower plate 2. According to the present disclosure, the inner side wall of the carrier plate 4 is engaged with the positioning plate 8 from inside to outside, and the outer side wall of the carrier plate 4 is abutted by the side positioning plate 63 from outside to inside, so that the carrier plate 4 is quickly and accurately positioned at a specified position, which greatly improves the efficiency.

1. A carrier plate positioning device for a multi-column high-precision polishing machine, comprising a lower plate and at least two upper plates that are provided on a machine body of the polishing machine, each upper plate being mounted with one carrier plate, wherein a center positioning assembly and a plurality of outer positioning assemblies are provided on the machine body, when the plurality of carrier plates provided with workpieces to be polished are placed on the lower plate, the center positioning assembly is placed on an array center of the plurality of carrier plates from top to bottom, then each outer positioning assembly positions a corresponding carrier plate between the outer positioning assembly and the center positioning assembly inwardly from an outer side of the lower plate, and then each carrier plate is engaged with the corresponding upper plate by moving the upper plate downwards.

2. The carrier plate positioning device for the multi-column high-precision polishing machine according to claim 1, wherein the center positioning assembly comprises a center positioning base fixed on the machine body, a center cylinder provided on the center positioning base, and a center transmission mechanism driven by the center cylinder, a positioning plate is connected to a lower end of the center transmission mechanism, the center cylinder drives the positioning plate to rotate and move up and down through the center transmission mechanism, and when the positioning plate moves downward to the lower plate, the positioning plate abuts against inner side walls of the plurality of carrier plates on the lower plate through rotation.

3. The carrier plate positioning device for the multi-column high-precision polishing machine according to claim 2, wherein the center cylinder is mounted on a cylinder base fixedly connected to an upper end of the center positioning base, the center transmission mechanism comprises a shaft sleeve fixedly connected to a lower end of the center positioning base and a center positioning shaft mounted in the shaft sleeve through a bearing, an upper end of the center positioning shaft is hinged to the center cylinder through a floating joint, and a lower end of the center positioning shaft is connected to the positioning plate.

4. The carrier plate positioning device for the multi-column high-precision polishing machine according to claim 3, wherein a wall of the shaft sleeve is axially provided with an inclined groove, a bolt-type roller needle bearing is provided along a radial direction of the shaft sleeve, a bolt end of the bolt-type roller needle bearing is radially locked on the central positioning shaft, a roller end is placed into the inclined groove, and when the center cylinder drives the center positioning shaft to move up and down, the roller end of the bolt-type roller needle bearing moves along the inclined groove to drive the center positioning shaft to rotate.

5. The carrier plate positioning device for the multi-column high-precision polishing machine according to claim 4, wherein the positioning plate comprises a plate body fixedly connected to the lower end of the center positioning shaft and a positioning ring provided on a lower side of the plate body, a side wall of the positioning ring is circumferentially provided with a plurality of arc-shaped engaging openings, and when the positioning ring moves downward to the lower plate along with the plate body, the inner side wall of each carrier plate is engaged with the corresponding arc-shaped engaging opening.

6. The carrier plate positioning device for the multi-column high-precision polishing machine according to claim 1, wherein each outer positioning assembly comprises a fixing bottom housing provided on the machine body and located the outer side of the lower plate, a side cylinder mounted on the fixing bottom housing, and a side positioning plate driven by the side cylinder through a side transmission mechanism, and when the plurality of carrier plates are placed on the lower plate, the side positioning plate is driven by the side transmission mechanism to approach the corresponding carrier plate from outside to inside and abuts against the outer side wall of the carrier plate.

7. The carrier plate positioning device for the multi-column high-precision polishing machine according to claim 6, wherein the side transmission mechanism comprises a rack and pinion mechanism and a rotating mechanism, the side cylinder drives the rotating mechanism to rotate through the rack and pinion mechanism, and the rotating mechanism drives the side positioning plate to move from the outer side of the lower plate to the inner side of the lower plate.

8. The carrier plate positioning device for the multi-column high-precision polishing machine according to claim 7, wherein the rack and pinion mechanism comprises a rack provided in the fixing bottom housing and connected to a telescopic rod of the side cylinder through a fisheye joint, and a gear horizontally arranged in the fixing bottom housing and engaged with the rack, the rotating mechanism comprises a rotating shaft vertically arranged and a swinging assembly horizontally arranged, a lower end of the rotating shaft is mounted on an inner ring of the gear, the lower end of the rotating shaft is mounted with a deep groove ball bearing provided in the fixing bottom housing and located on an upper side of the gear, an upper end of the rotating shaft is connected to the swinging assembly, the rotating shaft is driven to rotate by the gear, so as to drive the swinging assembly to swing, and the swinging assembly drives the side positioning plate to swing.

9. The carrier plate positioning device for the multi-column high-precision polishing machine according to claim 8, wherein the swinging assembly comprises a fixing base connected to the fixing bottom housing and a swinging arm horizontally arranged, an end of the swinging arm is fixedly connected to the upper end of the rotating shaft, and another end of the swinging arm is connected to the side positioning plate through a moving shaft vertically arranged.

10. The carrier plate positioning device for the multi-column high-precision polishing machine according to claim 1, wherein the workpiece to be polished is a sapphire chip substrate, and the carrier plate is a ceramic carrier plate.
